(19) United States
(12) Patent Application Publication
(10) Pub. No.: US 2026/0336219 A1
(43) Pub. Date: Oct. 29, 2026

(54) MANUFACTURING AN OBJECT USING THREE-DIMENSIONAL PRINTING AND COIL WINDING TECHNIQUES

(71) Applicant: International Business Machines Corporation, Armonk, NY (US)

(72) Inventors: Irving A. DURAN, Dubuque, IA (US); Ana Victoria LOPEZ MIRANDA, San Pedro Tlaquepaque (MX); Sarbajit Kumar RAKSHIT, Kolkata (IN); Carolina GARCIA DELGADO, Zapopan (MX)

(21) Appl. No.: 19/189,975

(22) Filed: Apr. 25, 2025

(51) Int. Cl. B29C 64/386; B29C 70/24; B33Y 10/00; B33Y 40/00; B33Y 50/00

(52) U.S. Cl. CPC B29C 64/386; B29C 70/24; B33Y 10/00; B33Y 40/00; B33Y 50/00

(57) ABSTRACT

An integrated coil winding and three-dimensional (3D) printing system may evaluate a 3D model of a 3D object to be manufactured; may identify, based on evaluating the 3D model, a first portion of the 3D object to be manufactured by filament coil winding and a second portion of the 3D object to be manufactured by 3D printing; may simulate a filament coil winding process and a 3D printing process for the 3D object to determine a manufacturing sequence for filament coil winding and 3D printing of the 3D object; and/or may perform, based on the manufacturing sequence, the filament coil winding process to manufacture the first portion of the 3D object and the 3D printing process to manufacture the second portion of the 3D object.

### BACKGROUND

This disclosure relates to three-dimensional (3D) printing, and more specifically, to manufacturing an object using 3D printing and coil winding techniques.

### SUMMARY

Some implementations described herein relate to a method. The method may include evaluating a 3D model of a 3D object to be manufactured. The method may include identifying, based on evaluating the 3D model, a first portion of the 3D object to be manufactured by filament coil winding and a second portion of the 3D object to be manufactured by 3D printing. The method may include simulating a filament coil winding process and a 3D printing process for the 3D object to determine a manufacturing sequence for filament coil winding and 3D printing of the 3D object. The method may include performing, based on the manufacturing sequence, the filament coil winding process to manufacture the first portion of the 3D object and the 3D printing process to manufacture the second portion of the 3D object, where the filament coil winding process and the 3D printing process are performed using an integrated coil winding and 3D printing system.

Some implementations described herein relate to a computer system. The computer system may include a processor set, one or more computer-readable storage media, and program instructions stored on the one or more computer-readable storage media to cause the processor set to perform operations. The operations may include evaluating a 3D model of a 3D object to be manufactured. The operations may include identifying, based on evaluating the 3D model, a first portion of the 3D object to be manufactured by filament coil winding and a second portion of the 3D object to be manufactured by 3D printing. The operations may include determining one or more coil winding parameters for filament coil winding the first portion and one or more 3D printing parameters for 3D printing the second portion. The operations may include performing, using a filament coil winding system of an integrated coil winding and 3D printing system, a filament coil winding process to manufacture the first portion of the 3D object based on the one or more coil winding parameters. The operations may include performing, using a 3D printing head of the integrated coil winding and 3D printing system, a 3D printing process to manufacture the second portion of the 3D object based on the one or more 3D printing parameters.

Some implementations described herein relate to a computer program product. The computer program product may include one or more computer-readable storage media and program instructions stored on the one or more computer-readable storage media to perform operations. The operations may include evaluating a 3D model of a 3D object to be manufactured. The operations may include identifying, based on evaluating the 3D model, a first portion of the 3D object to be manufactured by filament coil winding and a second portion of the 3D object to be manufactured by 3D printing. The operations may include simulating, using a reinforcement learning model, a filament coil winding process and a 3D printing process for the 3D object to determine a manufacturing sequence for filament coil winding and 3D printing of the 3D object, where the reinforcement learning model is used to iterate through a plurality of candidate manufacturing sequences using a plurality of candidate manufacturing parameters to determine the manufacturing sequence. The operations may include performing, based on the manufacturing sequence, the filament coil winding process to manufacture the first portion of the 3D object and the 3D printing process to manufacture the second portion of the 3D object, where the filament coil winding process and the 3D printing process are performed using an integrated coil winding and 3D printing system.

### BRIEF DESCRIPTION OF THE DRAWINGS

FIG. 1 is a diagram of an example computing environment for supporting 3D printing.

FIG. 2 is a diagram of an example implementation of an integrated coil winding and 3D printing system.

FIGS. 3A-3C are diagrams of an example implementation of an integrated coil winding and 3D printing process.

FIG. 4 is a flowchart of an example process associated with manufacturing an object using 3D printing and coil winding techniques.

FIG. 5 is a flowchart of an example process associated with manufacturing an object using 3D printing and coil winding techniques.

FIG. 6 is a flowchart of an example process associated with manufacturing an object using 3D printing and coil winding techniques.

### DETAILED DESCRIPTION

The following detailed description of example implementations refers to the accompanying drawings. The same reference numbers in different drawings may identify the same or similar elements.

3D printing may provide the ability to create complex and customized 3D objects while doing so with without (or with minimal) customized tooling such as custom molds or dies. However, while 3D printing enables designs to be turned into manufactured objects without the need for complex customized tooling, the actual process of manufacturing by 3D printing may be comparatively slower than other types of manufacturing such as stamping, extrusion, and casting.

Some implementations described herein provide a hybrid manufacturing approach that integrates filament coil winding with 3D printing to optimize the production of complex 3D objects by reducing manufacturing times and increasing manufacturing throughput. As described herein, different portions of a 3D object may be manufactured by different manufacturing techniques that are optimized for the selected portions. For example, an integrated coil winding and 3D printing system described herein may be used to evaluate a 3D model of a 3D object to be manufactured and to identify portions that can be produced using filament coil winding and portions that can be produced using 3D printing. The integrated coil winding and 3D printing system then simulates manufacturing the portions by filament coil winding and 3D printing processes to determine an optimal manufacturing sequence. for manufacturing the 3D object. The integrated coil winding and 3D printing system may manufacture the different portions by filament coil winding and 3D printing to manufacture the 3D object.

In this way, the hybrid manufacturing techniques described herein enable reduced processing times and increased manufacturing throughput to be achieved by optimizing manufacturing sequences and the associated manufacturing techniques for different portions of 3D object. By integrating filament coil winding and 3D printing into an integrated coil winding and 3D printing system, the hybrid manufacturing techniques described herein also conserve processing resources, memory resources, and network resources by reducing data exchanges between disparate manufacturing systems. Additionally, the hybrid manufacturing techniques described herein minimize manufacturing waste by optimizing material usage and reducing the need for rework or repair, thus conserving raw materials and energy resources.

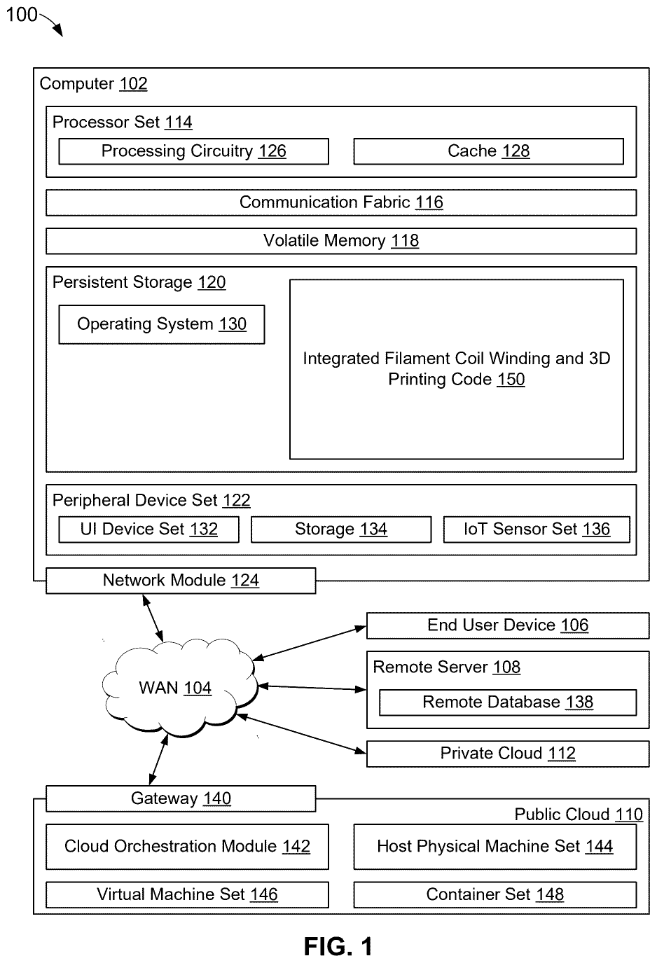

FIG. 1 is a diagram of an example computing environment 100 for supporting 3D printing.

The computing environment 100 contains an example of an environment for the execution of at least some of the computer code involved in performing the inventive methods, such as integrated filament coil winding and 3D printing code 150. In addition to the integrated filament coil winding and 3D printing code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the integrated filament coil winding and 3D printing code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in integrated filament coil winding and 3D printing code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the integrated filament coil winding and 3D printing code 150 typically includes at least some of the computer code involved in performing one or more operations described herein. In some implementations, the operations may include evaluating a 3D model of a 3D object to be manufactured; identifying, based on evaluating the 3D model, a first portion of the 3D object to be manufactured by filament coil winding and a second portion of the 3D object to be manufactured by 3D printing; simulating a filament coil winding process and a 3D printing process for the 3D object to determine a manufacturing sequence for filament coil winding and 3D printing of the 3D object; and performing, based on the manufacturing sequence, the filament coil winding process to manufacture the first portion of the 3D object and the 3D printing process to manufacture the second portion of the 3D object, where the filament coil winding process and the 3D printing process are performed using an integrated coil winding and 3D printing system.

In some implementations, the operations may include evaluating a 3D model of a 3D object to be manufactured; identifying, based on evaluating the 3D model, a first portion of the 3D object to be manufactured by filament coil winding and a second portion of the 3D object to be manufactured by 3D printing; determining one or more coil winding parameters for filament coil winding the first portion and one or more 3D printing parameters for 3D printing the second portion; performing, using a filament coil winding system of an integrated coil winding and 3D printing system, a filament coil winding process to manufacture the first portion of the 3D object based on the one or more coil winding parameters; and performing, using a 3D printing head of the integrated coil winding and 3D printing system, a 3D printing process to manufacture the second portion of the 3D object based on the one or more 3D printing parameters.

In some implementations, the operations may include evaluating a 3D model of a 3D object to be manufactured; identifying, based on evaluating the 3D model, a first portion of the 3D object to be manufactured by filament coil winding and a second portion of the 3D object to be manufactured by 3D printing; simulating, using a reinforcement learning model, a filament coil winding process and a 3D printing process for the 3D object to determine a manufacturing sequence for filament coil winding and 3D printing of the 3D object, where the reinforcement learning model is used to iterate through a plurality of candidate manufacturing sequences using a plurality of candidate manufacturing parameters to determine the manufacturing sequence; and performing, based on the manufacturing sequence, the filament coil winding process to manufacture the first portion of the 3D object and the 3D printing process to manufacture the second portion of the 3D object, where the filament coil winding process and the 3D printing process are performed using an integrated coil winding and 3D printing system.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (V CEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WA N 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

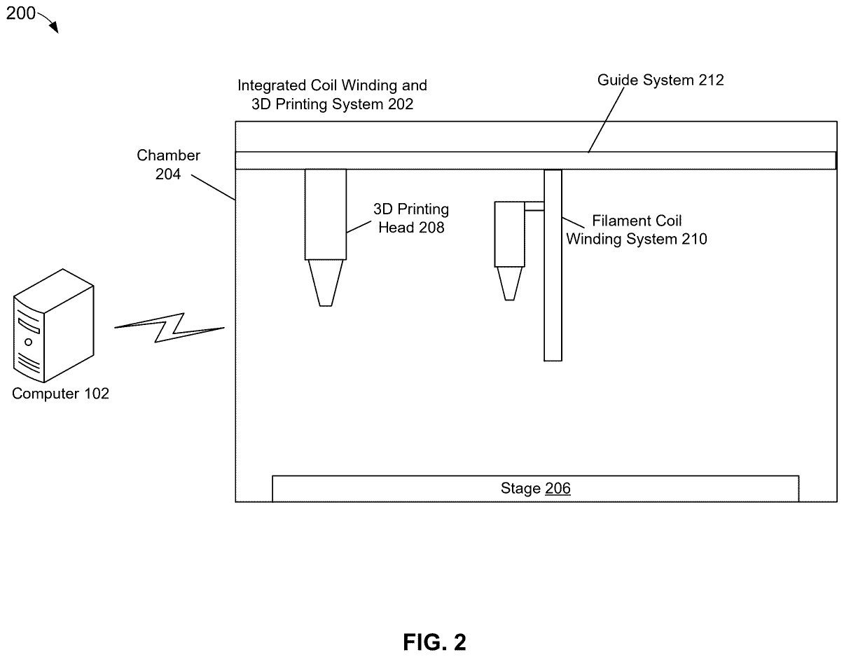

FIG. 2 is a diagram of an example implementation 200 of an integrated coil winding and 3D printing system 202. The integrated coil winding and 3D printing system 202 may be configured to manufacture 3D objects using a combination of filament coil winding and 3D printing techniques.

As shown in FIG. 2, the integrated coil winding and 3D printing system 202 may include a chamber 204 and a stage 206 within the chamber 204. A 3D printing head 208 and a filament coil winding system 210 may be located within the chamber 204 above the stage 206. The integrated coil winding and 3D printing head 208 may be coupled to a guide system 212 that enables the 3D printing head 208 and/or the filament coil winding system 210 to be moved and selectively positioned using computer numerical control (CNC).

The chamber 204 may include an internal volume and may include one or more sides that enclose the internal volume. Alternatively, one or more sides of the chamber 204 may be omitted such that the internal volume of the chamber is open and accessible.

In some implementations, the stage 206 includes a base plate, a chamber floor, a platen, and/or another type of horizontal surface that is configured to support and provide a substrate on which a 3D object is 3D printed.

In some implementations, the stage 206 is a build platform that is surrounded by walls to define a volume in which a powder bed may be contained. A powder stock and powder roller may be located adjacent to the build platform and may be configured to provide additional layers of powder to the powder bed for 3D printing. The build platform may be configured to be raised and/or lowered as layers of a 3D object are 3D printed.

The 3D printing head 208 may be configured to 3D print objects using one or more 3D printing techniques, such as fused deposition, stereolithography, binder jetting, and/or powder bed fusion, among other examples. The 3D objects that can be 3D printed by a 3D printing system 202 are not limited to any particular type of 3D object, and may include industrial components, consumer components, and/or other types of components.

In some implementations, the 3D printing head 208 is configured to provide the additive material for 3D printing a 3D object. For example, the 3D printing head 208 may include a material jet, a material extrusion nozzle, and/or another type of head through which material is deposited onto the stage 206 (or onto a 3D object that is being 3D printed on the stage 206).

In some implementations, the 3D printing head 208 is a fusion source that fuses material to a 3D object that is being 3D printed. For example, the 3D printing head 208 may include a laser head that melts or sinters material of a powder bed on the stage 206 to fuse powder from the powder bed to the 3D object being 3D printed. As another example, the 3D printing head 208 may include a laser head that cures a resin to solidify the resin to add material to a 3D object being 3D printed.

The filament coil winding system 210 may be configured to wind a wire filament around a spindle to form a filament coil winding. In some implementations, the spindle is interchangeable so that the filament coil winding system 210 can manufacture filament coil windings of different shapes. Examples of such shapes include circular filament coil windings, rectangular filament coil windings, ovular filament coil windings, conical filament coil windings, and/or triangular filament coil windings, among other examples. The filament coil winding system 210 may also include a nozzle through which the wire filament is dispensed.

The guide system 212 may include a combination of belts, gears, motors, structures, and/or other components that enable the 3D printing head 208 and/or the filament coil winding system 210 to be moved according to a programmed path. In some implementations, the guide system 212 includes a gantry to which the 3D printing head 208 and/or the filament coil winding system 210 is mounted. The computer 102 may control the movement of the 3D printing head 208 and/or the filament coil winding system 210 along the gantry by CNC programming.

As further shown in FIG. 2, the computer 102 may be communicatively coupled to the 3D printing system 202 and may control various aspects of the operation of the 3D printing system 202 and/or the components included therein. The computer 102 may be a part of the 3D printing system 202 and may correspond to the control system of the 3D printing system 202. In some implementations, the computer 102 is embedded in the form factor of the 3D printing system 202. In some implementations, the computer 102 is located remotely from the 3D printing system 202.

The computer 102 may communicate with components of the 3D printing system 202 over wired and/or wireless communication links using the network module 124 and/or the communication fabric 116, among other examples. The computer 102 may communicate with components of the 3D printing system 202 to control various aspects of the operation of the 3D printing system 202 to 3D print a portion of a 3D object and/or to coil wind a portion of the 3D object.

FIG. 2 is provided as an example. Other examples may differ from what is described with regard to FIG. 2.

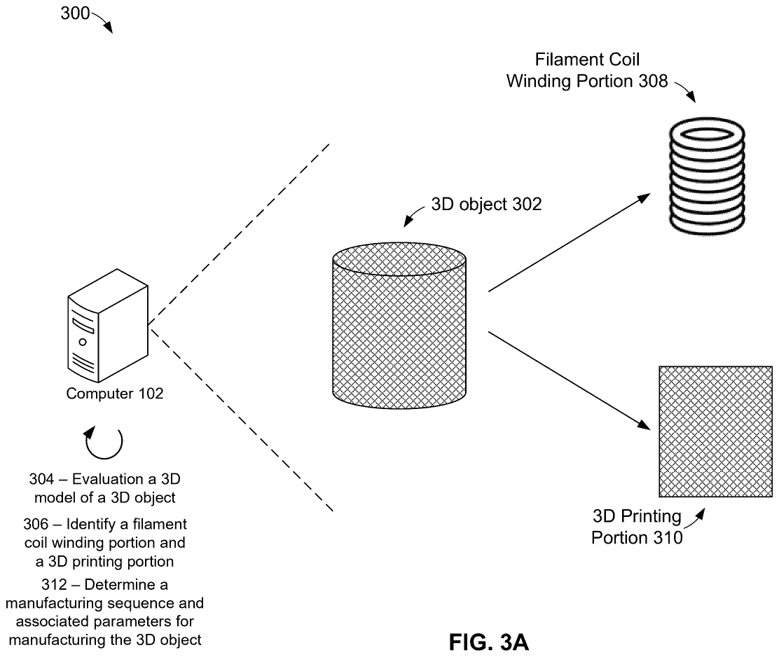

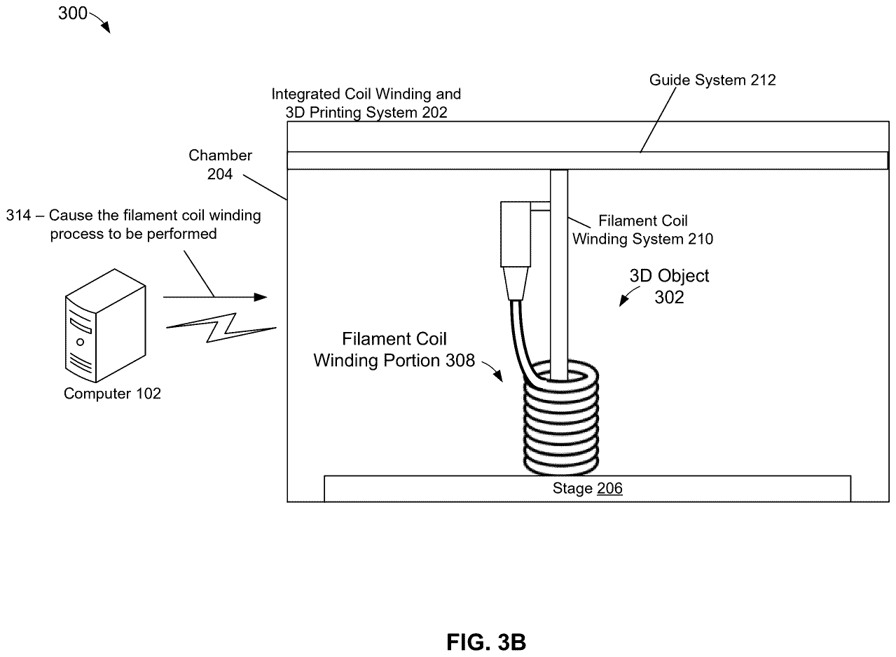

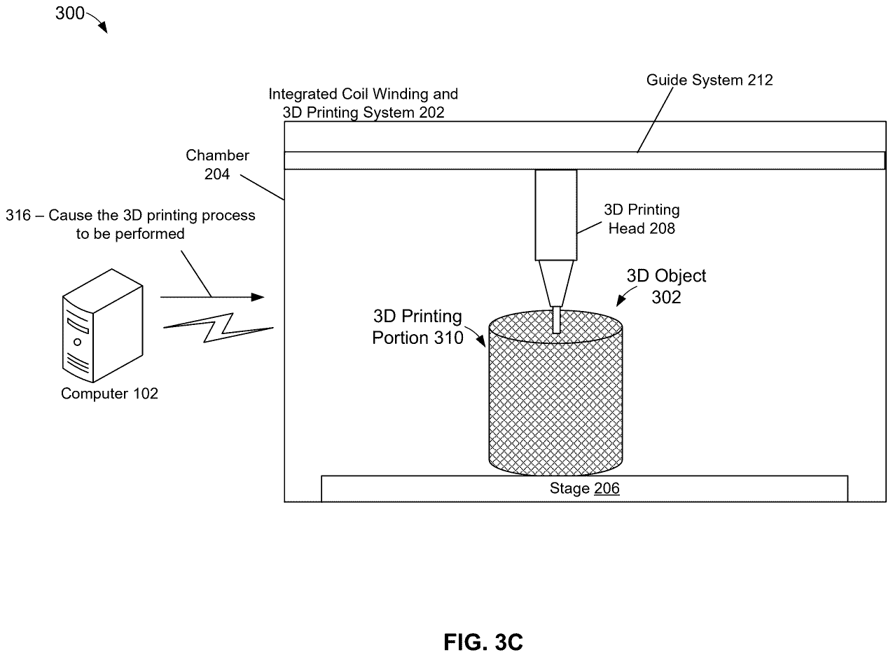

FIGS. 3A-3C are diagrams of an example implementation 300 of an integrated coil winding and 3D printing process. As shown in FIGS. 3A-3C, the integrated coil winding and 3D printing process may be performed to manufacture a 3D object 302 using the integrated coil winding and 3D printing system 202. The 3D object 302 is not limited to any particular type of object, and may include industrial components, consumer components, and/or other types of components.

As shown in FIG. 3A, at 304, the computer 102 may evaluate a 3D model of the 3D object 302. In some implementations, the computer 102 may execute the integrated filament coil winding and 3D printing code 150 to cause the computer 102 to evaluate the 3D model of the 3D object 302. The 3D model may correspond to an electronic 3D model design, such as a mesh model, of the 3D object 302.

The computer 102 may evaluate the 3D model to identify the size, shape, contours, textures, materials, and/or other attributes of the 3D object 302 that is to be manufactured. In some implementations, evaluating the 3D model may include performing one or more analyses of the 3D model, such as a finite element analysis, a thermal analysis, and/or another type of analysis. In some implementations, evaluating the 3D model may include segmenting the 3D model into a plurality of portions.

As further shown in FIG. 3A, at 306, the computer 102 may identify a filament coil winding portion 308 of the 3D object 302 and a 3D printing portion 310 of the 3D object 302. In some implementations, the computer 102 may execute the integrated filament coil winding and 3D printing code 150 to cause the computer 102 identify the filament coil winding portion 308 of the 3D object 302 and the 3D printing portion 310 of the 3D object 302.

The filament coil winding portion 308 may correspond to a portion of the 3D object 302 that is to be manufactured by filament coil winding (e.g., using the filament coil winding system 210), and the 3D printing portion 310 may correspond to a portion of the 3D object 302 that is to be manufactured by 3D printing (e.g., using the 3D printing head 208). In some implementations, the filament coil winding portion 308 is a main body of the 3D object 302, and the 3D printing portion 310 is a surface texture that is to be applied to the main body. In some implementations, the filament coil winding portion 308 is a first structural portion of the 3D object 302, and the 3D printing portion 310 is a second structural portion of the 3D object 302.

In some implementations, the computer 102 may identify the filament coil winding portion 308 of the 3D object 302 and the 3D printing portion 310 of the 3D object 302 based on the evaluation of the 3D model of the 3D object 302. For example, and as described above, evaluating the 3D model may include segmenting the 3D model into a plurality of portions. The computer 102 may then identify which segments are to be manufactured by filament coil winding (e.g., the filament coil winding portion(s) 308) and which segments are to be manufactured by 3D printing (e.g., the 3D printing portion(s) 310).

In some implementations, the computer 102 may determine whether to filament coil wind a segment of the 3D object 302 or to 3D print the segment by simulating a filament coil winding process and a 3D printing process for the segment of the 3D object 302. The simulation may include simulating manufacturing the segment by filament coil winding to determine the manufacturing time duration for manufacturing the segment by filament coil winding. The computer 102 may also determine the resulting quality level of the segment manufactured by filament coil winding, which may include attributes such as a surface finish quality, defect rate, and/or structural rigidity, among other examples. The simulation may include simulating manufacturing of the segment by 3D printing to determine such parameters for 3D printing the segment.

The computer 102 may then select filament coil winding or 3D printing for manufacturing the segment of the 3D object 302 based on the quality levels and manufacturing time durations. For example, if the manufacturing time duration for filament coil winding the segment is less than the manufacturing time duration for 3D printing the segment, and the quality level for filament coil winding the segment satisfies a quality level threshold, the computer 102 may select filament coil winding for the segment (e.g., the filament coil winding portion 308).

As another example, if the manufacturing time duration for filament coil winding the segment is greater than the manufacturing time duration for 3D printing the segment, and the quality level for 3D printing the segment satisfies a quality level threshold, the computer 102 may select 3D printing for the segment (e.g., the 3D printing portion 310).

As another example, if the quality level for filament coil winding the segment does not satisfy a quality level threshold, the computer 102 may select 3D printing for the segment (e.g., the 3D printing portion 310).

In some implementations, the computer 102 may determine which portions of a segment of the 3D object to filament coil wind and which portions of the segment to 3D print based on simulating manufacturing the segment of the 3D object 302. For example, the computer 102 may determine that a main body or base of the 3D object 302 can be manufactured from a filament coil winding on which a surface texture is applied by 3D printing. The simulation may be performed to determine the manufacturing time durations for each portion, as well as the overall 3D object 302, as well as the associated costs and material usage, to determine an optimal (or desired) combination of cost, time, efficiency, and/or quality.

As further shown in FIG. 3A, at 312, the computer 102 may determine a manufacturing sequence for filament coil winding and 3D printing the 3D object 302. In particular, the manufacturing sequence may include a sequence for forming the filament coil winding portion 308 by filament coil winding, and for forming the 3D printing portion 310 by 3D printing.

The computer 102 may also determine one or more manufacturing parameters for manufacturing the 3D object 302. The manufacturing parameters may include one or more filament coil winding parameters and/or one or more 3D printing parameters, among other examples.

In some implementations, the computer 102 may determine the one or more coil winding parameters for forming the filament coil winding portion 308. The one or more coil winding parameters may include a material type for the wire filament, a size of the wire filament (e.g., a filament diameter), a winding pressure that is to be applied for winding the wire filament, a preheating temperature, a coil winding shape, a bonding temperature for bonding the turns of the filament coil winding portion 308 together, a quantity of turns for winding the wire filament, and/or another parameter.

In some implementations, the computer 102 may determine the one or more 3D printing parameters for 3D printing the 3D printing portion 310 of the 3D object 302. The 3D printing parameters may include a printing speed, a movement path for the 3D printing head 208, a material deposition rate for the 3D printing head 208, a 3D printing technique, a power level (e.g., a laser power level) for the 3D printing head 208, and/or a type of material that is to be deposited, among other examples.

In some implementations, one or more of the manufacturing parameters are based on the shape, geometry, size, orientation, and/or complexity of the 3D object 302 that is to be printed. For example, the wire filament size and/or the quantity of turns may be based on the size and/or the shape of the filament coil winding portion 308. As another example, the 3D printing speed for the 3D printing head 208 may be based on the size and/or the shape of the 3D printing portion 310. As another example, the material type for the 3D printing portion 310 may be selected to achieve a high gap-filling performance for filling in gaps in the filament coil winding portion 308.

In some implementations, one or more of the manufacturing parameters may be based on another manufacturing parameter. For example, the preheating temperature may be based on the size of the wire filament selected for the filament coil winding portion 308. As another example, the winding pressure may be based on the preheating temperature and/or the size of the wire filament.

To determine the manufacturing sequence, the computer 102 may simulate a filament coil winding process to manufacture the filament coil winding portion 308 of the 3D object 302 and a 3D printing process to manufacture the 3D printing portion 310 of the 3D object 302. In particular, the computer 102 may simulate manufacturing the 3D object 302 by iterating through various candidate manufacturing sequences of filament coil winding and 3D printing to determine the manufacturing sequence that will be used to manufacture the filament coil winding portion 308 and the 3D printing portion 310 of the 3D object 302. The simulation may be performed to determine an optimal (or desired) combination of cost, time, efficiency, and/or quality for manufacturing the 3D object 302.

In some implementations, the computer 102 may simulate the filament coil winding process and the 3D printing process using a machine learning model that is trained on manufacturing data from a plurality of historical manufacturing processes for the same (or similar) type of 3D object 302. The computer 102 may use the machine learning model to optimize the hybrid manufacturing approach by optimizing the manufacturing sequence, selecting optimal parameters for each process (e.g., filament diameter, winding pressure, temperature), and ensuring the structural integrity and precision of the 3D object 302.

The integrated coil winding and 3D printing system 202 may generate the manufacturing data from a plurality of historical manufacturing processes using various types of sensors, such as real-time vision systems, strain gauges, thermocouples, and/or other types of sensors. For example, the integrated coil winding and 3D printing system 202 may generate filament diameters using real-time vision systems to measure filament thickness, and adjusting to ensure that the filament diameter is appropriate for structural integrity of the 3D object 302. As another example, the integrated coil winding and 3D printing system 202 may generate winding pressure data using sensors to monitor filament winding pressure, which can be used to prevent or reduce structural defects, and ensuring uniformity in the coil winding process.

As another example, the integrated coil winding and 3D printing system 202 may generate temperature control data using sensors to measure the preheating and bonding temperatures to ensure proper adhesion and bonding between filament layers. As another example, the integrated coil winding and 3D printing system 202 may generate bonding quality data using vision systems to assess the quality of layer bonding, and to detect defects or weak spots. As another example, the integrated coil winding and 3D printing system 202 may monitor process times from both 3D printing and filament winding for optimization of time-consuming steps and reducing overall process time.

As another example, the integrated coil winding and 3D printing system 202 may generate material usage data indicating material usage for coil winding and 3D printing for optimizing the cost and usage of materials. As another example, the integrated coil winding and 3D printing system 202 may generate filament layer thickness data that can be used to ensure consistent bonding and proper structural formation. As another example, the integrated coil winding and 3D printing system 202 may generate surface finish quality data using computer vision and texture analysis to evaluate the smoothness and quality of the surface of the 3D object 302.

In some implementations, the machine learning model is used in an unsupervised approach in which the manufacturing data and candidate manufacturing process parameters are provided as input to the machine learning model, and the computer 102 uses the machine learning model to perform dimensionality reduction with an autoencoder, followed by clustering with a K-Means analysis on a latent representation. The autoencoder may be effective for dimensionality reduction and anomaly detection, identifying potential defects or inefficiencies in the manufacturing process. K-Means clustering helps classify different process parameters and conditions (e.g., filament tension, bonding quality) into clusters, allowing the model to identify the optimal settings for precision and durability. The inputs may be passed through the autoencoder, which compresses the inputs into the latent space representation. The compressed latent vectors may be fed into the K-Means clustering algorithm to group the vectors into clusters that represent different coil winding and 3D printing conditions. The computer 102 may generate an output from the machine learning model that corresponds to anomaly detection and classification of optimal manufacturing conditions based on the clustering.

The autoencoder may be represented as:

AE(Xs,Xr)=gφ(fθ(Xs,Xr))

where, Xₛ and Xᵣ are the input sensor and process data, fθ(·) is the encoding function that maps the input to a latent space, and gφ(·) is the decoding function that reconstructs the input from the latent representation.

The reconstruction error e may be given by:

ϵ=∥Xs,Xr−gφ(fθ(Xs,Xr))∥

where ∥·∥ denotes the norm (e.g., L2 norm) used to measure the reconstruction error. If the reconstruction error exceeds a predefined threshold, the process is flagged as an anomaly.

The K-Means clustering algorithm may be represented as:

$$K - Means ( z ) = {arg min}_{\{ Cj \}} {\sum }_{i = 1}^{n} {‖ {z}_{i} - μ {C}_{j} ‖}^{2}$$

where zᵢ represents the latent space data point, μCⱼ represents the centroid of cluster Cⱼ, and the argmin function assigns each latent vector z to the nearest cluster centroid.

In some implementations, the machine learning model is used in a supervised approach. In these implementations, the machine learning model may be a reinforcement learning model that is used to iterate through a plurality of candidate manufacturing sequences using a plurality of candidate manufacturing parameters to determine the manufacturing sequence and the associated manufacturing parameters. The reinforcement learning model may be used for simulating and optimizing the manufacturing process by dynamically adjusting the combination of 3D printing and coil winding parameters and sequences. The reinforcement learning model may be used to learn, through trial and error, how to balance cost, time, and material quality, making the approach suitable for complex sequences in hybrid manufacturing. The computer 102 may generate an output from the reinforcement learning model that corresponds to optimized manufacturing parameters and a manufacturing sequence for manufacturing the 3D object 302.

The reinforcement learning model may be represented as:

R=f(T,C,Q)

where T is the total time of the process, C is the material cost, and Q is the quality metric based on structural integrity. The reinforcement learning model may be used to learn to adjust process parameters to maximize the reward R, which balances these factors.

In some implementations, the computer 102 may use a process classification system to classify the manufacturing sequence for filament coil winding and 3D printing of the 3D object 302 into one of a plurality of candidate manufacturing outcome classifications based on the set of manufacturing parameters. This process classification system may be used to categorize the process state for manufacturing the 3D object 302 based on the predicted structural quality, process time, and material cost, combined with other example attributes and outcomes.

In some implementations, the process classification system is a rule-based classification system. The rule-based classification system may be used to compare candidate manufacturing parameters to predefined thresholds to classify different process states (e.g., the different candidate manufacturing outcome classifications). Such candidate manufacturing outcome classifications may include, for example, an efficient process outcome, a costly process outcome, and/or an inefficient process outcome. For an example 3D object 302, the thresholds for an efficient process may correspond to a manufacturing time duration of less than 60 minutes and a material cost of less than $500. For an example 3D object 302, a costly process may correspond to a manufacturing time duration between 60 and 120 minutes, and a material cost between $500 and $1,000. For an example 3D object 302, an inefficient process may correspond to a manufacturing time duration of greater than 120 minutes or a material cost of greater than $1,000. These candidate outcomes and associated thresholds are examples, and other candidate outcomes and associated thresholds are within the scope of the present disclosure.

In some implementations, the process classification system is a machine learning classification system, and the computer 102 may use the machine learning classification system to classify the process state directly based on the outputs from the reinforcement learning model or the unsupervised approach. The computer 102 may validate the classification against manufacturing data to ensure that the system accurately estimates the process state and provides guidance for real-time adjustments.

As shown in FIGS. 3B and 3C, the integrated coil winding and 3D printing system 202 may perform the filament coil winding process to manufacture the filament coil winding portion 308 of the 3D object 302 and the 3D printing process to manufacture the 3D printing portion 310 of the 3D object 302 based on the determined manufacturing sequence and the associated manufacturing parameters. While FIGS. 3B and 3C illustrate the 3D printing portion 310 of the 3D object 302 being formed after the filament coil winding portion 308, in other examples the filament coil winding portion 308 may be formed after the 3D printing portion 310 of the 3D object 302.

Additionally and/or alternatively, forming the 3D object 302 may include forming a plurality of filament coil winding portions 308 and/or a plurality of 3D printing portions 310. The filament coil winding portions 308 and/or the 3D printing portions 310 may be formed in any particular order determined based on the simulation(s) performed by the computer 102.

In some implementations, the filament coil winding portion 308 and the 3D printing portion 310 are formed as separate structures that are subsequently assembled together to form the 3D object 302.

As shown in FIG. 3B, at 314, the computer 102 may provide one or more signals to the integrated coil winding and 3D printing system 202 to cause the integrated coil winding and 3D printing system 202 to form the filament coil winding portion 308 of the 3D object 302. The one or more signals may cause the guide system 212 to position the filament coil winding system 210, and may cause the filament coil winding system 210 to dispense a wire filament that the filament coil winding system 210 winds around the spindle to form the filament coil winding portion 308.

In some implementations, the one or more signals may cause the filament coil winding system 210 to preheat the wire filament prior to winding the wire filament around the spindle. Preheating the wire filament may increase the pliability of the wire filament so that the wire filament more easily winds around the spindle. Preheating may reduce the likelihood of kinks and/or other defects in the wire filament, and/or may reduce the winding pressure needed to wind the wire filament around the spindle.

During and/or after the wire filament is wound around the spindle to form the filament coil winding portion 308, the filament coil winding portion 308 may be heated to bond the turns of the filament coil winding portion 308 together. This may increase the structural rigidity of the filament coil winding portion 308, and may reduce the likelihood of the filament coil winding portion 308 from unwinding. In other words, heating the filament coil winding portion 308 to bond the turns of the filament coil winding portion 308 may promote retention of the shape of the filament coil winding portion 308.

In some implementations, the computer 102 may provide the one or more signals to the integrated coil winding and 3D printing system 202 to cause the filament coil winding system 210 to form the filament coil winding portion 308 by filament coil winding based on the one or more coil winding parameters. For example, the signal(s) may cause the filament coil winding system 210 to form the filament coil winding portion 308 from a particular material type (e.g., a thermoplastic such as polylactic acid (PLA), a metal such as copper (Cu)) for the wire filament. As another example, the signal(s) may cause the filament coil winding system 210 to form the filament coil winding portion 308 from a particular size of wire filament (e.g., a particular filament diameter). As another example, the signal(s) may cause the filament coil winding system 210 to apply a particular winding pressure for winding the wire filament. As another example, the signal(s) may cause the filament coil winding system 210 to preheat the wire filament to a particular preheating temperature. As another example, the signal(s) may cause the filament coil winding system 210 to apply a particular bonding temperature for bonding the turns of the filament coil winding portion 308 together. As another example, the signal(s) may cause the filament coil winding system 210 to form a particular quantity of turns for winding the wire filament.

As shown in FIG. 3C, at 316, the computer 102 may provide one or more signals to the integrated coil winding and 3D printing system 202 to cause the integrated coil winding and 3D printing system 202 to form the 3D printing portion 310 of the 3D object 302. The one or more signals may cause the guide system 212 to position and/or move the 3D printing head 208, and may cause the 3D printing head 208 to deposit and/or fuse material onto the 3D object 302 to form the 3D printing portion 310.

3D printing the 3D printing portion 310 of the 3D object 302 may include dispensing or depositing material through the 3D printing head 208 onto the filament coil winding portion 308 to build up the 3D printing portion 310 layer by layer. Additionally and/or alternatively, a powder fusion bed of material may be deposited onto and/or around the filament coil winding portion 308, and the 3D printing head 208 may emit a laser beam or ultraviolet (UV) radiation beam that is used to sinter or cure the material to build up the 3D printing portion 310 of the 3D object 302 layer by layer.

In some implementations, forming the 3D printing portion 310 may include depositing material over the filament coil winding portion 308 to form a surface texture of the 3D object 302. In some implementations, forming the 3D printing portion 310 may include depositing material into grooves, cracks, and/or openings in the filament coil winding portion 308 to fill in the grooves, cracks, and/or openings. In some implementations, forming the 3D printing portion 310 may include depositing material onto the filament coil winding portion 308 to form another structural portion of the 3D object 302 that extends from the filament coil winding portion 308.

In some implementations, the computer 102 may the provide one or more signals to the integrated coil winding and 3D printing system 202 to cause the integrated coil winding and 3D printing system 202 to 3D print the 3D printing portion 310 of the 3D object 302 based on one or more 3D printing parameters. For example, the signal(s) may cause the guide system 212 of the integrated coil winding and 3D printing system 202 to move the 3D printing head 208 along a movement path determined for the 3D printing parameters. As another example, the signal(s) may cause the 3D printing head 208 to use a particular 3D printing technique (e.g., binder jetting, powder bed fusion) based on the 3D printing parameters. As another example, the signal(s) may cause the 3D printing head 208 to dispense material at a rate that was determined for the 3D printing parameters. As another example, the signal(s) may cause the 3D printing head 208 to emit a laser beam at a power level that was determined for the set of printing parameters.

While the 3D printing head 208 is printing the 3D printing portion 310, the integrated coil winding and 3D printing system 202 may continue to generate data via sensors and validate against the machine learning model parameters to maintain a particular quality of the printing, such as filament diameter, winding pressure, temperature control, binding quality, process time, material cost, filament layer thickness, and/or surface finish quality.

After completion of the 3D object 302 (or after the filament coil winding and 3D printing operations), the computer 102 may rescan and reassess whether a quality of structure of the 3D object 302 satisfies the design and quality parameters for the 3D object 302. This may include scanning (e.g., using one or more sensors of the integrated coil winding and 3D printing system 202) the 3D object 302 after manufacturing the 3D object 302 to generate a 3D model representation of the 3D object 302 (e.g., of the as-manufactured 3D object 302). The computer 102 may compare the 3D model representation of the 3D object 302 to the 3D model of the 3D object 302 (e.g., the 3D design model) to determine if the 3D object 302 satisfies the design and quality parameters. If the computer 102 identifies a region of the 3D object 302 that is not within a tolerance of a parameter, the computer 102 may provide one or more signals to the integrated coil winding and 3D printing system 202 to cause the integrated coil winding and 3D printing system 202 to repair the 3D object 302.

In some implementations, the 3D printing head 208 may be used to repair the 3D object 302 by depositing and/or fusing additional material in the region. In some implementations, the filament coil winding system 210 may be used to repair the 3D object 302 by forming additional turns of the filament coil winding portion 308. In some implementations, other techniques may be used to repair the 3D object 302.

FIGS. 3A-3C are provided as an example. Other examples may differ from what is described with regard to FIGS. 3A-3C.

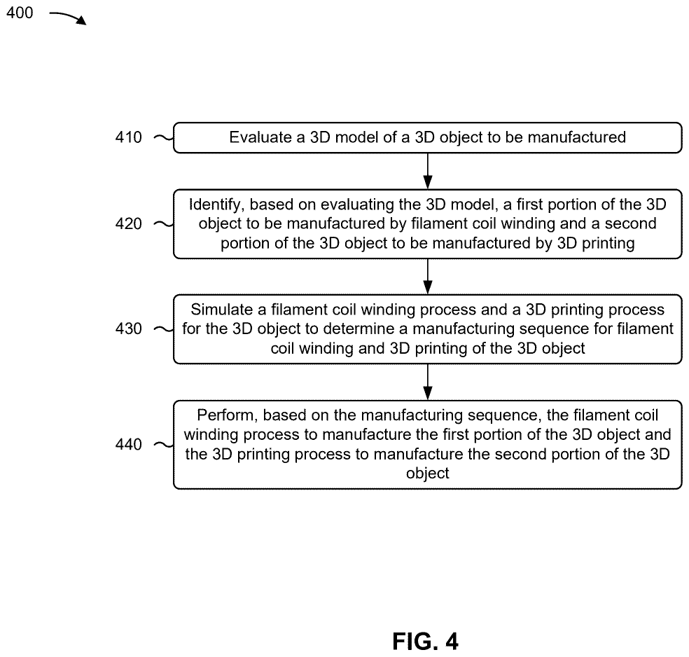

FIG. 4 is a flowchart of an example process 400 associated with manufacturing an object using 3D printing and coil winding techniques. One or more process blocks of FIG. 4 are performed by an integrated coil winding and 3D printing system (e.g., integrated coil winding and 3D printing system 202) and/or by another device or a group of devices separate from or including the integrated coil winding and 3D printing system, such as a computer 102. In some implementations, the computer 102 may execute the integrated filament coil winding and 3D printing code 150, to cause one or more of the operations of the process 400 to be performed. In some implementations, one or more components of the computer 102 may perform one or more operations of the process 400, such as the processor set 114, the communication fabric 116, the volatile memory 118, the persistent storage 120, the peripheral device set 122, and/or the network module 124, among other examples.

As shown in FIG. 4, process 400 includes evaluating a 3D model of a 3D object to be manufactured (block 410). For example, the integrated coil winding and 3D printing system may evaluate a 3D model of a 3D object to be manufactured, as described herein.

As further shown in FIG. 4, process 400 includes identifying, based on evaluating the 3D model, a first portion of the 3D object to be manufactured by filament coil winding and a second portion of the 3D object to be manufactured by 3D printing (block 420). For example, the integrated coil winding and 3D printing system may identify, based on evaluating the 3D model, a first portion of the 3D object to be manufactured by filament coil winding and a second portion of the 3D object to be manufactured by 3D printing, as described herein.

As further shown in FIG. 4, process 400 includes simulating a filament coil winding process and a 3D printing process for the 3D object to determine a manufacturing sequence for filament coil winding and 3D printing of the 3D object (block 430). For example, the integrated coil winding and 3D printing system may simulate a filament coil winding process and a 3D printing process for the 3D object to determine a manufacturing sequence for filament coil winding and 3D printing of the 3D object, as described herein.

As further shown in FIG. 4, process 400 includes performing, based on the manufacturing sequence, the filament coil winding process to manufacture the first portion of the 3D object and the 3D printing process to manufacture the second portion of the 3D object (block 440). For example, the integrated coil winding and 3D printing system may perform, based on the manufacturing sequence, the filament coil winding process to manufacture the first portion of the 3D object and the 3D printing process to manufacture the second portion of the 3D object, as described herein.

Process 400 may include additional implementations, such as any single implementation or any combination of implementations described below and/or in connection with one or more other processes described elsewhere herein.

In a first implementation, simulating the filament coil winding process and the 3D printing process includes simulating the filament coil winding process and the 3D printing process using a machine learning model that is trained on manufacturing data from a plurality of historical manufacturing processes for the 3D object.

In a second implementation, alone or in combination with the first implementation, performing the filament coil winding process includes selecting, based on evaluating the 3D model, a filament diameter for a wire filament of the first portion of the 3D object, selecting, based on evaluating the 3D model, a quantity of turns for the wire filament of the first portion of the 3D object, and using a filament coil winding system of the integrated coil winding and 3D printing system to perform the filament coil winding process to manufacture the first portion of the 3D object based on the filament diameter and the quantity of turns.

In a third implementation, alone or in combination with one or more of the first and second implementations, performing the filament coil winding process to manufacture the first portion of the 3D object includes applying, using the filament coil winding system, heat and pressure to bond adjacent layers of filament coils of the first portion of the 3D object.

In a fourth implementation, alone or in combination with one or more of the first through third implementations, performing the filament coil winding process includes preheating, using the filament coil winding system, the wire filament, and winding the wire filament for the quantity of turns after preheating the wire filament.

In a fifth implementation, alone or in combination with one or more of the first through fourth implementations, performing the 3D printing process includes using a 3D printing head of the integrated coil winding and 3D printing system to fill gaps between the turns of the wire filament to manufacture the second portion of the 3D object.

In a sixth implementation, alone or in combination with one or more of the first through fifth implementations, performing the 3D printing process includes forming, using a 3D printing head of the integrated coil winding and 3D printing system, a textured surface of the first portion to manufacture the second portion of the 3D object.

In a seventh implementation, alone or in combination with one or more of the first through sixth implementations, process 400 includes assembling the first portion and the second portion to form the 3D object.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

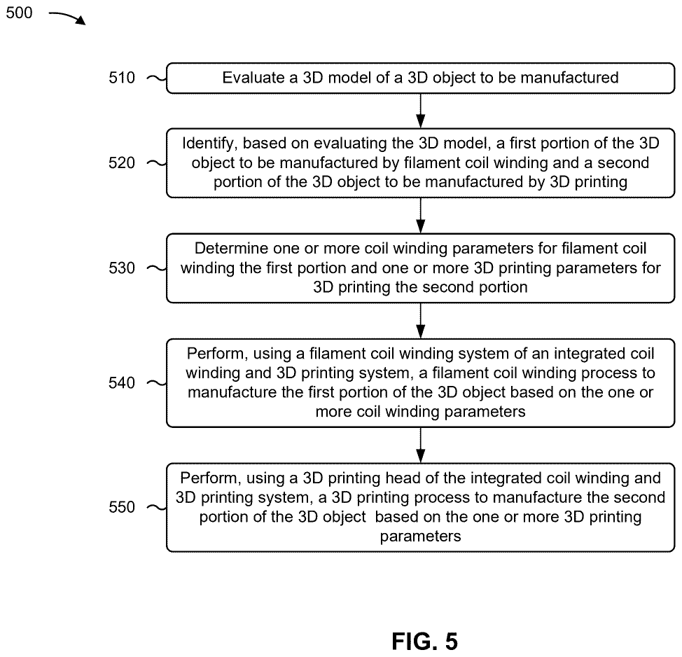

FIG. 5 is a flowchart of an example process 500 associated with manufacturing an object using 3D printing and coil winding techniques. One or more process blocks of FIG. 5 are performed by an integrated coil winding and 3D printing system (e.g., integrated coil winding and 3D printing system 202) and/or by another device or a group of devices separate from or including the integrated coil winding and 3D printing system, such as a computer 102. In some implementations, the computer 102 may execute the integrated filament coil winding and 3D printing code 150, to cause one or more of the operations of the process 500 to be performed. In some implementations, one or more components of the computer 102 may perform one or more operations of the process 500, such as the processor set 114, the communication fabric 116, the volatile memory 118, the persistent storage 120, the peripheral device set 122, and/or the network module 124, among other examples.

As shown in FIG. 5, process 500 includes evaluating a 3D model of a 3D object to be manufactured (block 510). For example, the integrated coil winding and 3D printing system may evaluate a 3D model of a 3D object to be manufactured, as described herein.

As further shown in FIG. 5, process 500 includes identifying, based on evaluating the 3D model, a first portion of the 3D object to be manufactured by filament coil winding and a second portion of the 3D object to be manufactured by 3D printing (block 520). For example, the integrated coil winding and 3D printing system may identify, based on evaluating the 3D model, a first portion of the 3D object to be manufactured by filament coil winding and a second portion of the 3D object to be manufactured by 3D printing, as described herein.

As further shown in FIG. 5, process 500 includes determining one or more coil winding parameters for filament coil winding the first portion and one or more 3D printing parameters for 3D printing the second portion (block 530). For example, the integrated coil winding and 3D printing system may determine one or more coil winding parameters for filament coil winding the first portion and one or more 3D printing parameters for 3D printing the second portion, as described herein.

As further shown in FIG. 5, process 500 includes performing, using a filament coil winding system of an integrated coil winding and 3D printing system, a filament coil winding process to manufacture the first portion of the 3D object based on the one or more coil winding parameters (block 540). For example, the integrated coil winding and 3D printing system may perform, using a filament coil winding system of an integrated coil winding and 3D printing system, a filament coil winding process to manufacture the first portion of the 3D object based on the one or more coil winding parameters, as described herein.

As further shown in FIG. 5, process 500 includes performing, using a 3D printing head of the integrated coil winding and 3D printing system, a 3D printing process to manufacture the second portion of the 3D object based on the one or more 3D printing parameters (block 550). For example, the integrated coil winding and 3D printing system may perform, using a 3D printing head of the integrated coil winding and 3D printing system, a 3D printing process to manufacture the second portion of the 3D object based on the one or more 3D printing parameters, as described herein.

Process 500 may include additional implementations, such as any single implementation or any combination of implementations described below and/or in connection with one or more other processes described elsewhere herein.

In a first implementation, determining the one or more coil winding parameters includes determining a coil winding shape for the first portion based on the 3D model.

In a second implementation, alone or in combination with the first implementation, identifying the first portion of the 3D object to be manufactured by filament coil winding includes identifying, based on the 3D model, the first portion for filament coil winding based on determining that an estimated quality metric for filament coil winding of the first portion satisfies a quality metric threshold.

In a third implementation, alone or in combination with one or more of the first and second implementations, identifying the first portion of the 3D object to be manufactured by filament coil winding includes identifying, based on the 3D model, the first portion for filament coil winding based on determining that an estimated quality metric for filament coil winding of the first portion is greater than an estimated quality metric for 3D printing the first portion.

In a fourth implementation, alone or in combination with one or more of the first through third implementations, identifying the first portion of the 3D object to be manufactured by filament coil winding includes identifying, based on the 3D model, the first portion for filament coil winding based on determining that an estimated filament coil winding time for the first portion is less than an estimated 3D printing time for the first portion.

In a fifth implementation, alone or in combination with one or more of the first through fourth implementations, determining the one or more 3D printing parameters includes determining the one or more 3D printing parameters using a reinforcement learning model to determine areas in the first portion in which gaps are to be filled in by 3D printing.

In a sixth implementation, alone or in combination with one or more of the first through fifth implementations, the operations include scanning the 3D object after manufacturing the 3D object to generate a 3D model representation of the 3D object, comparing the 3D model representation of the 3D object to the 3D model of the 3D object to identify a region of the 3D object that is to be repaired, and repairing the region of the 3D object using the 3D printing head.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

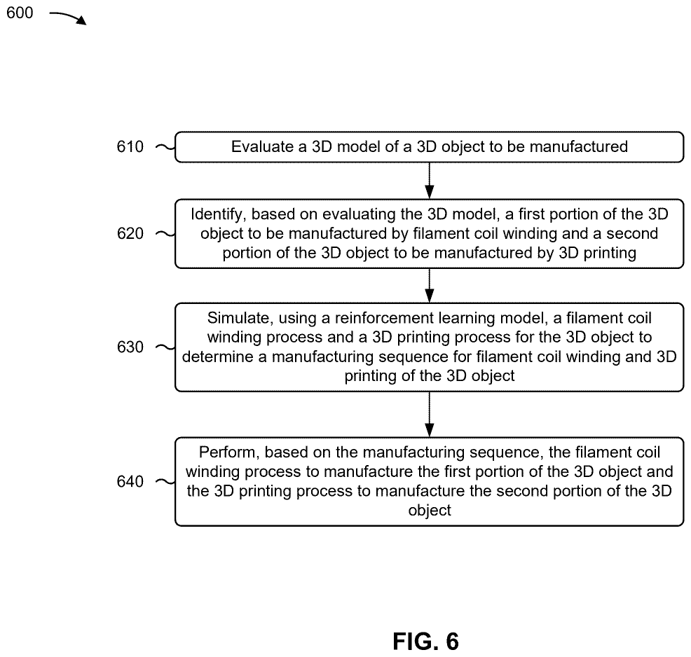

FIG. 6 is a flowchart of an example process 600 associated with manufacturing an object using 3D printing and coil winding techniques. One or more process blocks of FIG. 5 are performed by an integrated coil winding and 3D printing system (e.g., integrated coil winding and 3D printing system 202) and/or by another device or a group of devices separate from or including the integrated coil winding and 3D printing system, such as a computer 102. In some implementations, the computer 102 may execute the integrated filament coil winding and 3D printing code 150, to cause one or more of the operations of the process 500 to be performed. In some implementations, one or more components of the computer 102 may perform one or more operations of the process 500, such as the processor set 114, the communication fabric 116, the volatile memory 118, the persistent storage 120, the peripheral device set 122, and/or the network module 124, among other examples.

As shown in FIG. 6, process 600 includes evaluating a 3D model of a 3D object to be manufactured (block 610). For example, the integrated coil winding and 3D printing system may evaluate a 3D model of a 3D object to be manufactured, as described herein.

As further shown in FIG. 6, process 600 includes identifying, based on evaluating the 3D model, a first portion of the 3D object to be manufactured by filament coil winding and a second portion of the 3D object to be manufactured by 3D printing (block 620). For example, the integrated coil winding and 3D printing system may identify, based on evaluating the 3D model, a first portion of the 3D object to be manufactured by filament coil winding and a second portion of the 3D object to be manufactured by 3D printing, as described herein.

As further shown in FIG. 6, process 600 includes simulating, using a reinforcement learning model, a filament coil winding process and a 3D printing process for the 3D object to determine a manufacturing sequence for filament coil winding and 3D printing of the 3D object (block 630). For example, the integrated coil winding and 3D printing system may simulate, using a reinforcement learning model, a filament coil winding process and a 3D printing process for the 3D object to determine a manufacturing sequence for filament coil winding and 3D printing of the 3D object, as described herein. In some implementations, the reinforcement learning model is used to iterate through a plurality of candidate manufacturing sequences using a plurality of candidate manufacturing parameters to determine the manufacturing sequence.

As further shown in FIG. 6, process 600 includes performing, based on the manufacturing sequence, the filament coil winding process to manufacture the first portion of the 3D object and the 3D printing process to manufacture the second portion of the 3D object (block 640). For example, the integrated coil winding and 3D printing system may perform, based on the manufacturing sequence, the filament coil winding process to manufacture the first portion of the 3D object and the 3D printing process to manufacture the second portion of the 3D object, as described herein.

Process 600 may include additional implementations, such as any single implementation or any combination of implementations described below and/or in connection with one or more other processes described elsewhere herein.

In a first implementation, the plurality of candidate manufacturing parameters include at least one of a filament diameter for a wire filament of the first portion of the 3D object, a winding pressure for winding the wire filament, a preheating temperature for preheating the wire filament prior to winding the wire filament, or a bonding temperature for bonding the wire filament after winding the wire filament.

In a second implementation, alone or in combination with the first implementation, the plurality of candidate manufacturing parameters include at least one of a material type for 3D printing the second portion of the 3D object, a 3D printing technique for 3D printing the second portion of the 3D object, an amount of material that is to be used for 3D printing the second portion of the 3D object, or a material cost for the material that is to be used for 3D printing the second portion of the 3D object.

In a third implementation, alone or in combination with one or more of the first and second implementations, simulating the filament coil winding process and the 3D printing process for the 3D object includes using the reinforcement learning model to generate a set of manufacturing parameters, based on the plurality of candidate manufacturing parameters, for the manufacturing sequence for filament coil winding and 3D printing of the 3D object.

In a fourth implementation, alone or in combination with one or more of the first through third implementations, the operations include classifying the manufacturing sequence for filament coil winding and 3D printing of the 3D object into one of a plurality of candidate manufacturing outcome classifications based on the set of manufacturing parameters.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. M any modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
evaluating a three-dimensional (3D) model of a 3D object to be manufactured;
identifying, based on evaluating the 3D model, a first portion of the 3D object to be manufactured by filament coil winding and a second portion of the 3D object to be manufactured by 3D printing;
simulating a filament coil winding process and a 3D printing process for the 3D object to determine a manufacturing sequence for filament coil winding and 3D printing of the 3D object; and
performing, based on the manufacturing sequence, the filament coil winding process to manufacture the first portion of the 3D object and the 3D printing process to manufacture the second portion of the 3D object,
wherein the filament coil winding process and the 3D printing process are performed using an integrated coil winding and 3D printing system.

2. The method of claim 1, wherein simulating the filament coil winding process and the 3D printing process comprises:
simulating the filament coil winding process and the 3D printing process using a machine learning model that is trained on manufacturing data from a plurality of historical manufacturing processes for the 3D object.

3. The method of claim 1, wherein performing the filament coil winding process comprises:
selecting, based on evaluating the 3D model, a filament diameter for a wire filament of the first portion of the 3D object;
selecting, based on evaluating the 3D model, a quantity of turns for the wire filament of the first portion of the 3D object; and
using a filament coil winding system of the integrated coil winding and 3D printing system to perform the filament coil winding process to manufacture the first portion of the 3D object based on the filament diameter and the quantity of turns.

4. The method of claim 3, wherein performing the filament coil winding process to manufacture the first portion of the 3D object comprises:
applying, using the filament coil winding system, heat and pressure to bond adjacent layers of filament coils of the first portion of the 3D object.

5. The method of claim 4, wherein performing the filament coil winding process comprises:
preheating, using the filament coil winding system, the wire filament; and
winding the wire filament for the quantity of turns after preheating the wire filament.

6. The method of claim 3, wherein performing the 3D printing process comprises:
using a 3D printing head of the integrated coil winding and 3D printing system to fill gaps between the turns of the wire filament to manufacture the second portion of the 3D object.

7. The method of claim 3, wherein performing the 3D printing process comprises:
forming, using a 3D printing head of the integrated coil winding and 3D printing system, a textured surface of the first portion to manufacture the second portion of the 3D object.

8. The method of claim 1, further comprising:
assembling the first portion and the second portion to form the 3D object.

9. A computer system comprising:
a processor set;
one or more computer-readable storage media; and
program instructions stored on the one or more computer-readable storage media to cause the processor set to perform operations comprising:
evaluating a three-dimensional (3D) model of a 3D object to be manufactured;
identifying, based on evaluating the 3D model, a first portion of the 3D object to be manufactured by filament coil winding and a second portion of the 3D object to be manufactured by 3D printing;
determining one or more coil winding parameters for filament coil winding the first portion and one or more 3D printing parameters for 3D printing the second portion;
performing, using a filament coil winding system of an integrated coil winding and 3D printing system, a filament coil winding process to manufacture the first portion of the 3D object based on the one or more coil winding parameters; and
performing, using a 3D printing head of the integrated coil winding and 3D printing system, a 3D printing process to manufacture the second portion of the 3D object based on the one or more 3D printing parameters.

10. The computer system of claim 9, wherein determining the one or more coil winding parameters comprises:
determining a coil winding shape for the first portion based on the 3D model.

11. The computer system of claim 9, wherein identifying the first portion of the 3D object to be manufactured by filament coil winding comprises:
identifying, based on the 3D model, the first portion for filament coil winding based on determining that an estimated quality metric for filament coil winding of the first portion satisfies a quality metric threshold.

12. The computer system of claim 9, wherein identifying the first portion of the 3D object to be manufactured by filament coil winding comprises:
identifying, based on the 3D model, the first portion for filament coil winding based on determining that an estimated quality metric for filament coil winding of the first portion is greater than an estimated quality metric for 3D printing the first portion.

13. The computer system of claim 9, wherein identifying the first portion of the 3D object to be manufactured by filament coil winding comprises:
identifying, based on the 3D model, the first portion for filament coil winding based on determining that an estimated filament coil winding time for the first portion is less than an estimated 3D printing time for the first portion.

14. The computer system of claim 9, wherein determining the one or more 3D printing parameters comprises:
determining the one or more 3D printing parameters using a reinforcement learning model to determine areas in the first portion in which gaps are to be filled in by 3D printing.

15. The computer system of claim 9, wherein the operations comprise:
scanning the 3D object after manufacturing the 3D object to generate a 3D model representation of the 3D object;
comparing the 3D model representation of the 3D object to the 3D model of the 3D object to identify a region of the 3D object that is to be repaired; and
repairing the region of the 3D object using the 3D printing head.

16. A computer program product comprising:
one or more computer-readable storage media; and
program instructions stored on the one or more computer-readable storage media to perform operations comprising:
evaluating a three-dimensional (3D) model of a 3D object to be manufactured;
identifying, based on evaluating the 3D model, a first portion of the 3D object to be manufactured by filament coil winding and a second portion of the 3D object to be manufactured by 3D printing;
simulating, using a reinforcement learning model, a filament coil winding process and a 3D printing process for the 3D object to determine a manufacturing sequence for filament coil winding and 3D printing of the 3D object,
wherein the reinforcement learning model is used to iterate through a plurality of candidate manufacturing sequences using a plurality of candidate manufacturing parameters to determine the manufacturing sequence; and
performing, based on the manufacturing sequence, the filament coil winding process to manufacture the first portion of the 3D object and the 3D printing process to manufacture the second portion of the 3D object,
wherein the filament coil winding process and the 3D printing process are performed using an integrated coil winding and 3D printing system.

17. The computer program product of claim 16, wherein the plurality of candidate manufacturing parameters include at least one of:
a filament diameter for a wire filament of the first portion of the 3D object,
a winding pressure for winding the wire filament,
a preheating temperature for preheating the wire filament prior to winding the wire filament, or
a bonding temperature for bonding the wire filament after winding the wire filament.

18. The computer program product of claim 16, wherein the plurality of candidate manufacturing parameters include at least one of:
a material type for 3D printing the second portion of the 3D object,
a 3D printing technique for 3D printing the second portion of the 3D object,
an amount of material that is to be used for 3D printing the second portion of the 3D object, or
a material cost for the material that is to be used for 3D printing the second portion of the 3D object.

19. The computer program product of claim 16, wherein simulating the filament coil winding process and the 3D printing process for the 3D object comprises:
using the reinforcement learning model to generate a set of manufacturing parameters, based on the plurality of candidate manufacturing parameters, for the manufacturing sequence for filament coil winding and 3D printing of the 3D object.

20. The computer program product of claim 19, wherein the operations comprise:
classifying the manufacturing sequence for filament coil winding and 3D printing of the 3D object into one of a plurality of candidate manufacturing outcome classifications based on the set of manufacturing parameters.
